(19) United States
(12) Patent Application Publication
(10) Pub. No.: US 2010/0017981 A1
(43) Pub. Date: Jan. 28, 2010

(54) DRAIN CLEANING TOOLS WITH WEAR INDICATORS

(75) Inventors: James E. Hamm, Grafton, OH (US); Paul W. Gress, Bay Village, OH (US)

Correspondence Address: RANKIN, HILL & CLARK LLP, 38210 Glenn Avenue, WILLOUGHBY, OH, 44094-7808, US

(73) Assignee: EMERSON ELECTRIC CO., St. Louis, MO (US)

(21) Appl. No.: 12/178,331

(22) Filed: Jul. 23, 2008

(51) Int. Cl. B08B 9/027

(52) U.S. Cl. 15/104.33

(57) ABSTRACT

A drain cleaning tool includes a wear indicator for providing a visual indication to a user of the tool of an amount of wear in the tool. Various forms of the wear indicator and tool include a flexible plumbers cable with one or more wear detector prominences extending between turns of the cable, a tool carried on the end of the cable and couplings on the opposite ends of the cable. The flexible plumbers cable includes an elongate hollow outer body member defining a longitudinal axis and a resilient intermediate body carried within the outer body. The resilient intermediate body carried within the outer body has along its periphery at least one wear detector prominence extending radially outwardly between at least one selected turn of the helically coiled outer body. The at least one wear detector has at least one color change in the radial direction to provide a visual indication visual indication to a user of the tool of an amount of wear in the tool. Further, a tool on an end of a flexible plumbers cable includes a wear detector. A flexible plumbers cable section includes an elongate cable portion, first and second coupling portions on opposite ends of the cable section, and a wear indicator on the coupling portions.

### BACKGROUND OF THE INVENTION

1. Field of the Invention

The present application relates to methods and apparatus for detecting and determining wear in drain cleaning apparatus. More particularly, the present application relates to wear indicator methods and apparatus for enabling tool users to better detect and determine wear in the working elements of drain cleaning apparatus such as cables, commonly referred to as “snakes,” couplings used with sectional cables, and cutting or other attachments for the cables or snakes. Typically, such cables can be single integral cables, or selectively adjustable lengths formed by engaging two or more cable sections or portions together. The remaining useful life in those working elements can also be monitored over time by observing the one or more wear indicator apparatus and/or by using the described methods.

The claimed invention will be described in connection with the preferred embodiments. However, it is to be appreciated that the embodiments of the invention have use in equipment other than drain cleaning equipment, and in other applications such as in determining wear in working elements of any pipe or conduit cleaning apparatus, coring tools, boring apparatus, drilling tools, or other similar devices.

2. Description of Related Art

Drain cleaning tools operate in harsh environments. In many cases the drains are impacted with hardened debris such as tree roots, boiler scale, grease, and the like. In some cases, the chemicals are caustic. Also, the drain itself often includes hard walls, sharp edges at joints and tortuous turns along its tubing string. All of these factors and others cause the drain cleaning tools to wear during use.

Tools for cleaning drains include plumbers cables which are nearly always used with specialized tools integrated into or carried on the free or distal end thereof. One such simple tool is a bulb auger formed by the free end of the cable. Other specialized tools include removable hard tools such as chain knockers, augers such as funnel or hook augers, and cutters such as spade, saw tooth, spiral saw tooth or shark tooth cutters. Soft tools may be used with the cables as well. These typically include specialized brushes and the like for finish cleaning of passageways. The specialized tools are typically selectively connected to the distal working end of the cable using quick connect couplings or other similar mechanisms. Sectional drain cleaning cables include similar couplings on opposite ends thereof so that the cable can be easily carried to the job site in short sections then assembled end-to-end as needed to service the drain.

For best results, the cables are preferably rotated while within the target pipe or drain. Various prime mover devices have been used for this purpose including hand operated crank-type devices for homeowner applications and electric motor prime movers, such as sectional or drum machines, for larger or industrial applications. The latter include K-750 and K-1500 model drain cleaners available from Ridge Tool Company for example.

In a typical drum machine set up, a rotatable drum carries a reserve of the snake with a working portion of the snake extending from the drum often through a linear feed control device. The user selectively extends the snake into the clogged pipe using the linear feed control mechanism. The feed control is also used afterwards to retract the cable from the pipe. In a sectional machine, the pay out of cable is by hand. Regardless of the device, for best results, linear cable feeding typically occurs while the prime mover rotates the cable to help it auger through the obstruction. Further, the snake may be used in a mode of simply rotating within the pipe without linear motion for extended periods in order to generally open the pipe along the length of the snake by lateral movement thereof within the pipe as bends in the cable “sweep” past the inner walls of the pipe. This has the effect of “polishing” the initial cleaning operation performed during cable insertion. Thereafter, the operator may retract the snake out from the pipe workpiece and back onto the rotating drum by hand feed or by selectively operating the linear feed control. Special soft tools may be used as well on the end of the cable, such as a brush to polish the inner walls of the pipe.

Wear can be identified in a general sense by an inspection of the “flats” formed over time on the outside of the cable. Typically, the cables are made from round wire and, therefore, the outwardly directed circular bumps of new cables are rounded like the profile of the wire forming the cable. The use of wire having other cross sectional shapes is also known. However, by abrasion during use, the pronounced bumps tend to wear down. Obvious “flats” formed through use on the outside of the cable indicate that it is worn and should be replaced.

It is difficult, however, for an operator to determine an amount of acceptable wear sustained by a drain cleaning tool. Therefore, it is difficult to determine whether a drain cleaning tool should be replaced, and if not immediately replaced, how much useable life associated with the tool remains. As a result, it is common for tools to be prematurely replaced by diligent operators and for other tools to be overly used by inattentive or unaware operators.

Generally, as wear of the cable snake increases, the tendency for the snake to twist or kink increases. The excessively worn portion of the snake may also lose its rigidity and thus become excessively flexible in that region, thereby also contributing to a tendency for twisting or kinking. This causes a great deal of aggravation. Worse, a portion of an excessively worn cable can break off. This requires a large time investment in retrieving the broken portion of the snake from the pipe and causes further aggravation.

In other cases, portions of the specialized tool on the end of the cable break off during use if excessively worn. In general, the specialized tools simply lose effectiveness as they wear.

One solution is to replace the snake or snake portion at predefined regular intervals. However, this can be wasteful if the snake or portion thereof is not yet worn to a state of an imminent fracture.

Therefore, it is desirable to provide a drain cleaning tool with a wear indicator to provide a visual indication of wear on the drain cleaning tool. The wear indicator may be in the form of a wear element wear indicator carried by the drain cleaning tool or a wear feature formed in, on or adhered to the drain cleaning tool.

Preferably, a wear indicator is provided on a drain cleaning tool in the form of a wear element wear indicator such as a disc for example on a flexible plumbers cable or a wear feature wear indicator such as a ridge, groove, dimple or coating on the flexible plumbers cable.

Still further, a wear indicator is provided on a drain cleaning tool in the form of a wear indicator on the connectors at the ends of sectional drain cleaning cable and/or on the couplings for connecting various operative tools to the cable.

Yet still further, it is preferred that a wear indicator is provided on a drain cleaning tool in the form of a wear indicator on a working member carried on the distal end of a plumbers cable.

Yet still further, it is preferred that a wear indicator is provided on a drain cleaning tool in the form of a wear indicator on couplings on opposite ends of sectional plumbers cable.

### BRIEF DESCRIPTION OF THE INVENTION

In accordance with one preferred embodiment, a flexible plumbers cable is provided having an elongate outer body member defining a longitudinal axis, and a resilient intermediate body carried by the outer body. The resilient intermediate body has along its periphery at least one wear detector prominence extending radially outwardly for wearing as the cable wears so that an operator may determine a wear condition of the plumbers snake. The outer body member is formed of a length of steel wire helically coiled in turns along the longitudinal axis. The wire thus formed then defines a hollow region which, in one form, may receive an inner body such as a plastic or metal carrier or form, or the wire may be wound directly onto the plastic or metal carrier. In another form, an inner body is not disposed or otherwise received in the hollow region of the cable. In its preferred form, the at least one wear detector prominence extends radially outwardly between at least one selected turn of the helically coiled outer body and has at least one color change in the radial direction. In that way, the color of the prominence changes as it wears together with the wear of the adjacent body member of the plumbers snake. This provides a visual indication of wear on the cable. The flexible cable may be of a single unitary construction such as having lengths of fifty (50), seventy five (75) or one hundred (100) feet or it may be in the form of a series of sectional cables, typically of seven and one half (7½), ten (10) or fifteen (15) foot lengths, selectively coupled at their ends.

In one aspect, the resilient intermediate body member is disk-shaped and includes a circular central body portion, and the at least one wear detector prominence is annular and carried on the intermediate body member. The wear detector prominence may be formed integrally with the central body portion. In one embodiment, the intermediate body of the flexible plumbers snake forms a slit extending radially through the central body portion and the at least one wear detector prominence, to enable portions of the body adjacent said slit to be spaced apart along said longitudinal axis for contouring the body into a helical coil in accordance with said steel wire along said horizontal axis.

In another preferred form, the resilient intermediate body member extends longitudinally within the outer body, and the wear detector prominence extends radially outwardly between a plurality of turns of the helically coiled outer body. The wear detector prominence is spiral shaped. Here the elongate hollow outer body has opposite proximal and distal ends, and the resilient intermediate body member may extend longitudinally within the outer body substantially entirely between the proximal and distal ends. As desired, the wear detector prominence may include a plurality of wear detector prominences carried by intermediate body member at locations spaced apart along said longitudinal axis or may be spiral shaped and extend substantially entirely between the proximal and distal ends of the elongate hollow outer body. In the former, the wear detector prominence can be useful as a length marker when provided on the cable at fixed regular intervals such as, for example, every ten (10) feet. In the latter, the wear detector prominence may be useful in identifying an amount of plumbers cable to be trimmed from the working end thereof because it has reached the end of its useful life.

In yet another form, the flexible plumbers snake further includes a plurality of resilient intermediate body members carried by the outer body at locations spaced apart along said longitudinal axis, each of the plurality of resilient intermediate body members having along its periphery at least one wear detector prominence extending radially outwardly including at least one color change in said radial direction. The resilient intermediate body members can be useful as well if provided on the cable at fixed regular intervals such as, for example, every ten (10) feet.

As desired, the at least one color change of the wear detector is a color gradient in said radial direction. The color gradient may include a one of a light to dark gradient in said radial direction and a dark to light gradient in the radial direction or any combination thereof. Further, the color gradient may include a green to yellow change in the radial direction, and a yellow to red change in the radial direction.

Preferably, portions of the wear detector prominence extending radially outwardly beyond the outer radial extent of the cable body is smooth in circumferential and longitudinal directions so it does not snag on the pipe workpiece during use.

The elongate hollow outer body of the flexible plumbers snake may be formed of a length of spring steel, and the wear detector prominence may be formed of a plastic material.

Still further, the plumbers snake may include an inner concentrically aligned flexible metal or plastic core disposed within the elongate hollow outer body and extending longitudinally thereof, the resilient intermediate body member being disposed between the metal core and the outer body.

The hollow outer body of the flexible plumbers snake may include a length of steel wire formed of a double wound coil with adjacent convolutions of the coil being in substantial abutment with one another. A wide variety of cable sizes, shapes and configurations now known or developed in the future can be used. The hollow outer body may receive plastic or metal carrier members singularly or in multiples thereof by the flexible plumbers cable being wound thereon.

In accordance with yet a further preferred embodiment, a tool for use on the distal end of a flexible plumbers snake is provided. The tool includes a body including a connection portion for selectively connecting the body of the tool with the distal end of the plumbers snake, a working member carried on the body, and a wear indicator on at least one of the body and the working member. The working member is configured for cleaning debris within an associated drain during use of the tool, and the wear indicator provides a visual indication of wear on the tool.

In its preferred form, the body defines a substantially cylindrical shaped outer surface, and the wear indicator is a formation defined on the outer surface. The formation is at least one of a raised protuberance formed on the outer surface or a recess formed on said outer surface.

In another form, the working member includes a blade having an edge for cutting the debris within the associated drain during use of the tool, and the wear indicator includes a formation defined on the blade. Here, the formation is at least one of a raised protuberance formed on the blade and a hole adjacent said edge and extending through the blade.

In accordance with yet a still further preferred embodiment, a flexible plumbers cable section is provided. The cable section includes an elongate outer body member defining a longitudinal axis, first and second coupling portions on opposite ends of the cable section, and a wear indicator on at least one of the first and second coupling portions. The outer body of the cable section is formed of a length of steel wire helically coiled in turns along the longitudinal axis. The first coupling portion is attached with a first end of the elongate outer body member and the second coupling portion is attached with a second end of the elongate outer body member opposite from the first end. The first and second coupling portions are selectively intermatable with each other to connect together multiples of the elongate outer body member provided with the first and second couplings portions on said opposite ends thereof. The wear indicator on at least one of the first and second coupling portions provides a visual indication of wear on the flexible plumbers cable section.

In its preferred form, the first coupling portion includes a first body, a first cable connection portion, and a male quick connect portion. The first body is substantially cylindrical shaped. The first cable connection portion is disposed on one side of the first body for coupling the first coupling portion with the first end of outer body member of the cable portion. The male quick connect portion is disposed on the other side of the first body and is configured for selective attachment with the second coupling member. Similarly, the second coupling portion includes a second body, a second cable connection portion, and a female quick connect portion. The second body is substantially cylindrical shaped. The second cable connection portion is disposed on one side of the second body for coupling the second coupling portion with the second end of outer body member of the cable portion. The female quick connect portion is disposed on the other side of the second body and is configured for selective attachment with the male coupling member.

In accordance with yet a still further preferred embodiment, a flexible plumbers cable is provided including an elongate outer body member defining a longitudinal axis, and a wear indicator member carried by the outer body member. The elongate outer body member defines a longitudinal axis and is formed of a length of steel wire helically coiled in turns along the longitudinal axis. The wear indicator member carried by the outer body member has along its outer periphery at least one wear detector prominence extending radially outwardly from the helically coiled outer body member.

In one form, the at least one wear detector prominence has at least one color change in the radial direction providing a visual indication of wear on the cable.

In another form, the wear indicator member carried by the outer body member is a hollow cylindrical member clamped to the outer periphery of the outer body member. The hollow cylindrical member may be a one of a steel clamp and a plastic clamp. Further, the hollow cylindrical member is a one of a metal clamp and a plastic clamp such as for example a pull tie clamp.

In still another form, the wear indicator member carried by the outer body member is a coating adhered to the outer periphery of the outer body member. The coating is a one of an epoxy and paint. Further, the epoxy may be a rubberized epoxy.

In one aspect, the wear indicator is a formation defined on at least one of the first and second outer surfaces of the first and second coupling portions.

In another aspect, the formation is a one of a raised protuberance, and a recess. The protuberances and/or recesses may be arranged to form symbols intelligible to human operators of the plumbers cable section.

### BRIEF DESCRIPTION OF THE DRAWINGS

The foregoing aspects and others will be pointed out more fully hereinafter in conjunction with the written description of the preferred embodiments of the invention illustrated in the accompanying drawings in which:

FIG. 1 is a perspective view of a sewer cleaning machine carrying a drain cleaning tool with wear indicators in accordance with the preferred embodiments of the invention;

FIG. 2 is a longitudinal view of a central portion of the plumbers snake 26 of FIG. 1 shown in elevation;

FIG. 2A is a longitudinal view of a central portion of a plumbers snake carrying a wear element wear indicator of another embodiment;

FIG. 2B is a partial cross sectional view of the snake and wear indicator depicted in FIG. 2;

FIG. 3A is a perspective view of a wear element wear indicator in accordance with a first preferred form;

FIG. 3B is a perspective view of the wear element wear indicator of FIG. 3A in a relaxed condition;

FIG. 4 is an elevational view of the wear element wear indicator of FIG. 3B;

FIG. 5 is a cross-sectional view of the wear element wear indicator taken along 5-5 of FIG. 4;

FIG. 5A is a cross-sectional view of an alternative form of the wear element wear indicator of FIG. 5;

FIG. 5B is a cross-sectional view of another alternative form of the wear element wear indicator of FIG. 5;

FIG. 5C is a cross-sectional view of another alternative form of the wear element wear indicator of FIG. 5;

FIG. 5D is a cross-sectional view of another alternative form of the wear element wear indicator of FIG. 5;

FIG. 5E is a partial cross sectional view of the wear indicator of FIG. 5 disposed between adjacent coils of wire;

FIG. 6 is a longitudinal view of a central portion of a plumbers snake showing a wear element wear detector in accordance with a further embodiment;

FIG. 6A is a partial cross sectional view of the snake and wear indicator depicted in FIG. 6;

FIG. 7 is a view of the wear element wear indicator of FIG. 6 with the plumbers snake removed;

FIG. 8 is a perspective view of a wear element wear indicator in accordance with a further embodiment;

FIG. 8A is a partial cross sectional view of the snake and wear indicator depicted in FIG. 8;

FIG. 9 is a perspective view of a wear element wear indicator in accordance with yet a further embodiment;

FIG. 10 is a perspective view of a tool including a plurality of wear feature wear indicators in accordance with further embodiments;

FIG. 11 is a partial elevational view of the tool of FIG. 10 in a wear condition;

FIG. 12 is a perspective view of a plumbers cable section and couplings including a plurality of wear feature wear indicators in accordance with still further preferred embodiments;

FIG. 13 is a longitudinal view of a central portion of a plumbers snake showing a wear element wear detector in accordance with a still further embodiment;

FIG. 14 is a longitudinal view of a central portion of a plumbers snake showing a wear feature wear detector in accordance with yet a still further embodiment;

FIG. 15 is a cross section of another alternative form of the wear indicator prior to any significant wear; and

FIG. 16 is a cross section of the indicator in FIG. 15 after significant wear.

### DETAILED DESCRIPTION OF THE PREFERRED EMBODIMENTS

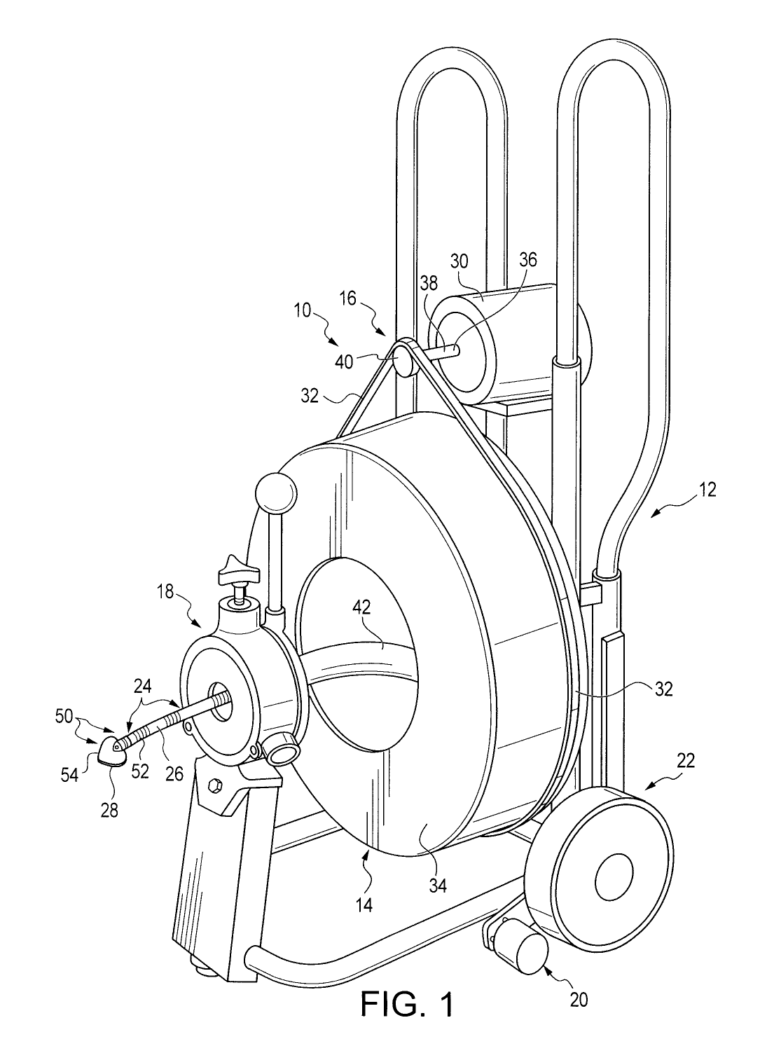

With reference now to the drawings where the showings are for purposes of illustrating the preferred embodiments of the invention only and not for purposes of limiting same, a portable sewer cleaning machine 10 is shown in FIG. 1 as comprising a wheeled frame assembly 12 supporting a rotatable snake drum unit 14, a drum driving arrangement 16, a snake feeding mechanism 18, and machine stabilizer components 20. Frame assembly 12 is provided with a pair of wheels 22 by which machine 10 is adapted to be supported for rolling movement from one location to another along an underlying surface. The drum unit 14 contains a flexible drain cleaning tool 24 in the form of a snake 26 carrying a cutting tool 28 on the distal end thereof. Hereinafter, both the cable 26 and the cutting tool 28 may be referred to as a cleaning tool or simply as a tool. Also hereinafter, couplers on either the cable or the tool or both may be referred to as a cleaning tool or simply as a tool. As well, the couplers on opposite ends of sectional drain cleaning cables or other cables may be referred to as a cleaning tool or simply as a tool. In the embodiment shown, the proximal end of the snake is stored in a coiled arrangement within the rotatable drum unit 14.

The drive unit 16 of the sewer cleaning machine 10 includes an electric drive motor 30 which is adapted to drive an endless belt 32 which engages about the outer periphery of a drum housing 34 of the drum unit 14. Further in this respect, the motor 30 has a drive shaft 36 rotatable about drive shaft axis 38 and provided with a drive pulley 40 about which the belt 32 is trained, whereby the belt is driven in response to rotation of the shaft to rotate the drum housing 34. Preferably, the pulley and the portion of the belt exposed above the drum housing are covered for protective purposes by a suitable guard (not shown).

As is well known, drum housing 34 contains the coiled spring wire plumbers snake 26, and a guide tube 42 serves to guide displacement of the snake into and out of the housing 34 during use of the machine in a manner which provides for the snake to be coiled and uncoiled during its displacement relative to the housing. While the guide tube is illustrated and described herein as being a part of the drum unit, this is merely a possible arrangement of the tube and the tube could be supported adjacent its axially outer end for rotation, in which case it could be free of a mounted interconnection with the drum unit. Further the drum housing and hub could be provided as integral or separate components. Additionally, the particular cleaning apparatus 10 of FIG. 1 is not critical for the subject drain cleaning tool 24 which can be used, in various sizes and configurations and styles and in any other form of cleaning apparatus such as, for example sectional machines such as the K-1500 Series, rodder machines such as the K-1000 Series, drum machines such as the K-750 Series, and sink machines, all of which are sold by Ridge Tool Company and others as well. Sectional machines use relatively short, e.g. 10 foot, plumbers cable sections which are selectively coupled from end to end with like cable sections using suitable selectively intermatable connectors provided on opposite ends thereof.

In accordance with the preferred embodiments of the present invention, the drain cleaning tool 24 includes at least one wear indicator 50 for generating a visual indication of an amount of wear sustained by the tool. The visual indication helps an operator to determine if the tool is new, if it can be further used, or whether it is at or near the end of its useful life. In one form, the wear indicator 50 is provided on the snake 26 as a wear element 52 carried on or by the cable or integrated into the body of the cable and, in another form, it is provided as a wear feature 54 on the cutting tool 28 or elsewhere in the drain cleaning system such as on the couplers at opposite ends of sectional or other cables or on the connector bodies of the tool 28 and cable. The embodiments of each will be described in greater detail below.

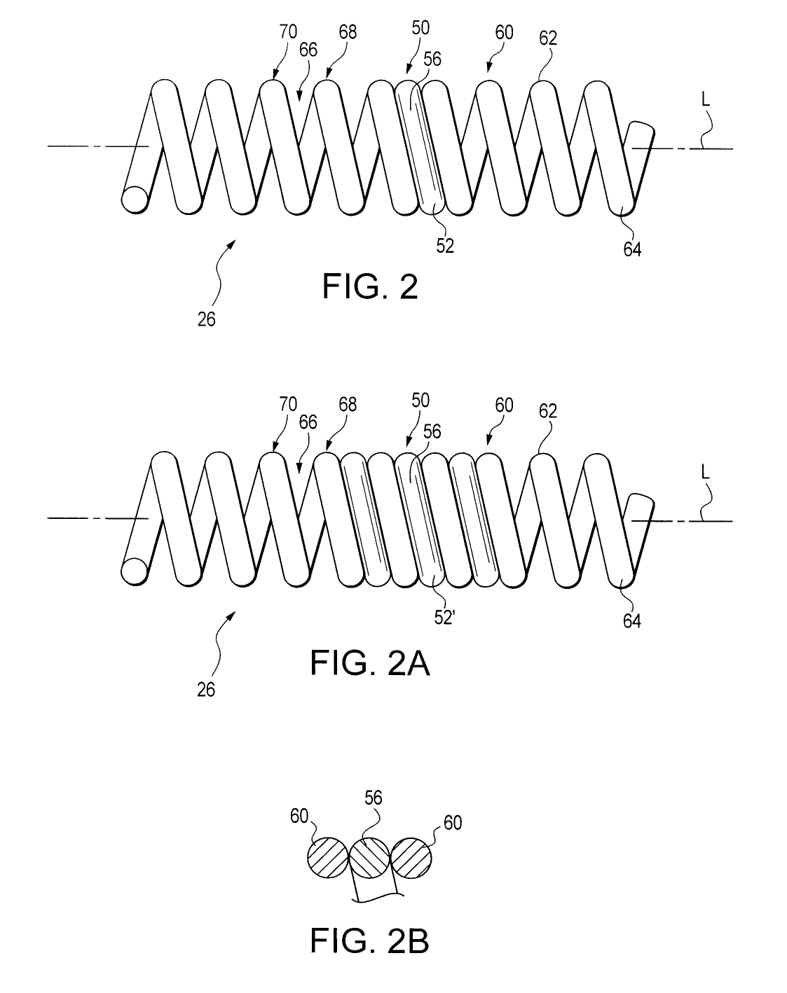

FIG. 2 is a longitudinal sectional view of a central portion of the plumbers snake 26 of FIG. 1 carrying a wear indicator 50 in the form of a wear element 52. In particular, the wear element is a wear disk 56 in accordance with a first preferred embodiment. As understood by those skilled in the art, plumbers snakes and drain cleaning cables in general are available in many forms and having a variety of sizes and structural configurations often selected based upon an intended application. The embodiments of the subject inventive wear element find use in all snakes however constructed. The snake 26 shown in FIG. 2 is a hollow core (HC) cable 60 and can be seen to comprise an elongate hollow outer body member generally designated as 62 formed of a length of helically coiled spring steel wire 64, the turns of which are coiled along a longitudinal axis L. The turns of the spring wire 64 are arranged singularly (a single turn cable) in an axially spaced apart relation thereby defining a helical gap 66 between opposite mutually adjacent leading 68 and trailing 70 turn pairs. The gap shown is for illustrative purposes only as other hollow core cables may have gaps of different sizes and of different relative sizes.

The wear disk 56 is preferably positioned in the gap 66 at a selected location therealong such as shown in the figure so that it is carried rotationally along with the cable 60 during use of the snake 26. In that way, the wear disk can be subjected to the same wear conditions as the body member 62 of the cable 60 so that the disk and cable wear at the same or similar way and rate.

As noted, the wear element is configured to provide a visual wear level indication to an operator using the sewer cleaning machine 10 in a manner to be described herein. The visual wear level indication developed by the wear element is used to infer the wear on the cable body member 62 because, as noted, the wear element and cable are subjected to the same conditions during use of the cable and, therefore, preferably, they wear at the same or similar way and rate. The wear disk 56 embodiment illustrated has all of these desirable characteristics. Essentially, the wear on the indicator 50 is observed and acts as a proxy for wear on the cable 26.

In its preferred form, the wear disk 56 has a generally circular shape and is formed of a resilient material such as nylon, plastic or from any other one or more materials having suitable chemical tolerance characteristics relative to various staining and caustic solutions typically encountered in sewer, drain, and other pipes. In addition, it is important for the wear disk 56 to be resilient yet bendable so that it can be twisted into shape in conformance with the helical gap 66 for installation onto the cable 60.

The installation of the disk 56 may be performed by hand, machine or otherwise after the cable 60 is provided or may be inserted into the cable during its manufacture such as by hand but preferable by machine. In the hand installation, the end user of the cable simply bends the cable by hand causing the gap between adjacent turns of the cable coil to spread apart and open providing an increased gap having a dimension large enough to accommodate the disk 56. Thereafter, the user simply inserts the disk into the hollow inner region of the cable to the position shown in FIG. 2, for example, so that it may be carried by the cable during use thereof. One example of machine forming includes simultaneously co-winding the disk with the steel wire 64 forming the cable 26. In another method, ends of the cable or spaced apart regions of the cable may be drawn apart whereupon the disk is inserted into the enlarged gap thereby created and, afterwards, permitting the wire 64 to relax thereby gripping the disk element 52 in the gap 66 between adjacent convolutions. During insertion, the disk and/or cable may be manipulated using various means to locate the wear indicator on the cable without damage to either component.

It is to be appreciated that certain cable configurations are more amenable in accommodating the disk after manufacture, such as in a retrofit of the wear indicator 50 onto an existing snake. These include snakes having cables with a large diameter or a large gap between adjacent convolutions of the wire. Retrofitting the wear indicator onto smaller cables of the type typically used in drum machines or hand tools is possible though slightly more difficult.

During manufacture, however, the disk 56 may be positioned adjacent the wire as it is formed and then wound into the coiled helix together with the wire. In one embodiment, the disk or wear element is elongate and makes multiple revolutions in the longitudinal direction of the cable. One form of this is shown in FIG. 2A wherein the wear element 52′ extends about three (3) full revolutions along the longitudinal axis L. In another embodiment, both the wear element and the wire are wound onto an associated elongate plastic or metal carrier member in side by side or shoulder to shoulder abutment. Other methods for providing or inserting the wear elements described herein may be utilized as well.

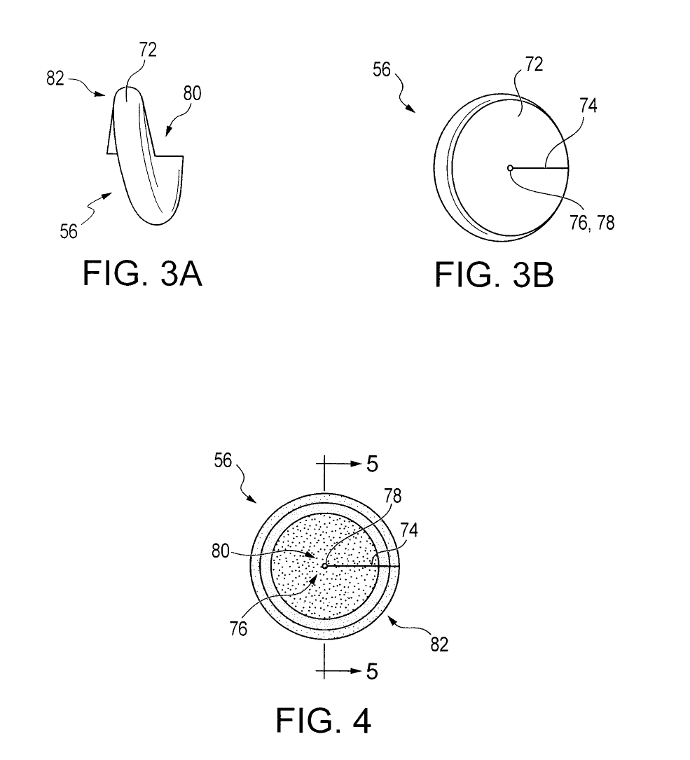

FIG. 3A shows a perspective view of the wear disk 56 twisted into a shape similar to the shape shown in FIG. 2 as held by the cable 60, but with the cable removed for ease of discussion. Although the disk 56 can be manufactured from a somewhat stiff material such as a stiff nylon or the like, in the shape shown in the figure, it is preferred that the disk is provided as a resilient flat circular disk 72 such as shown in FIG. 3B, and then bent or twisted into a spiral or helical shape as the disk is installed onto the cable 60 in the helical gap 66 either during manufacture of the snake or afterwards by a user. To help facilitate bending for installation and bending during use of the cable, the disk includes a slit 74 extending radially outwardly from a central area 76 of the disk preferably provided in the form of an enlarged circular opening 78 located centrally of the disk 72. For use with the open body single turn cable of about ⅜ or ½ inch pitch of FIG. 2, the disk 72 preferably has a thickness of about 0-½ inch or larger. However, the thickness may be varied as necessary for application onto other snakes having various other shapes or configurations. It will be appreciated that the wear disk 56 shown in FIG. 3A could be manufactured or otherwise formed in the stressed shape depicted in this figure. The present invention also includes forming a wear disk in different configurations and degrees of deformation.

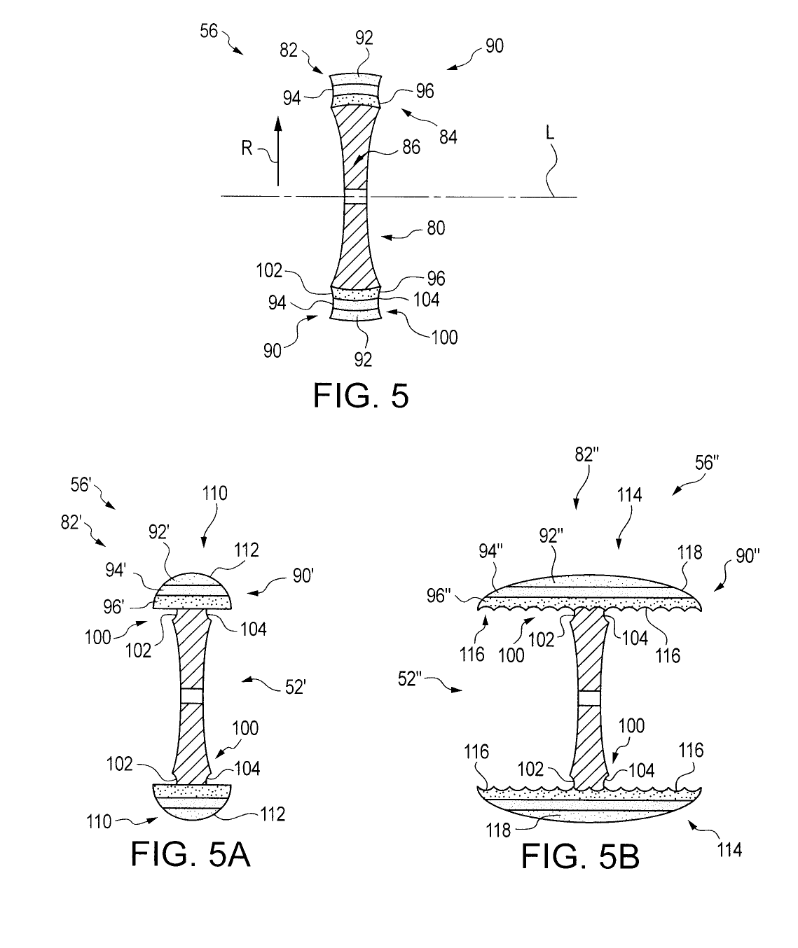

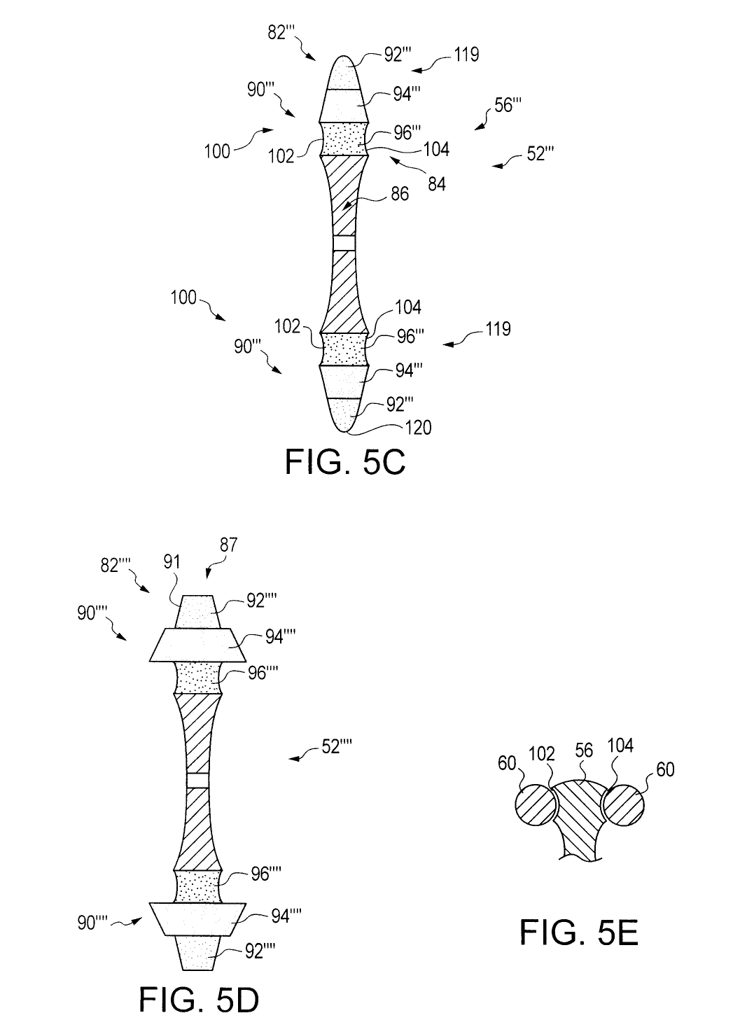

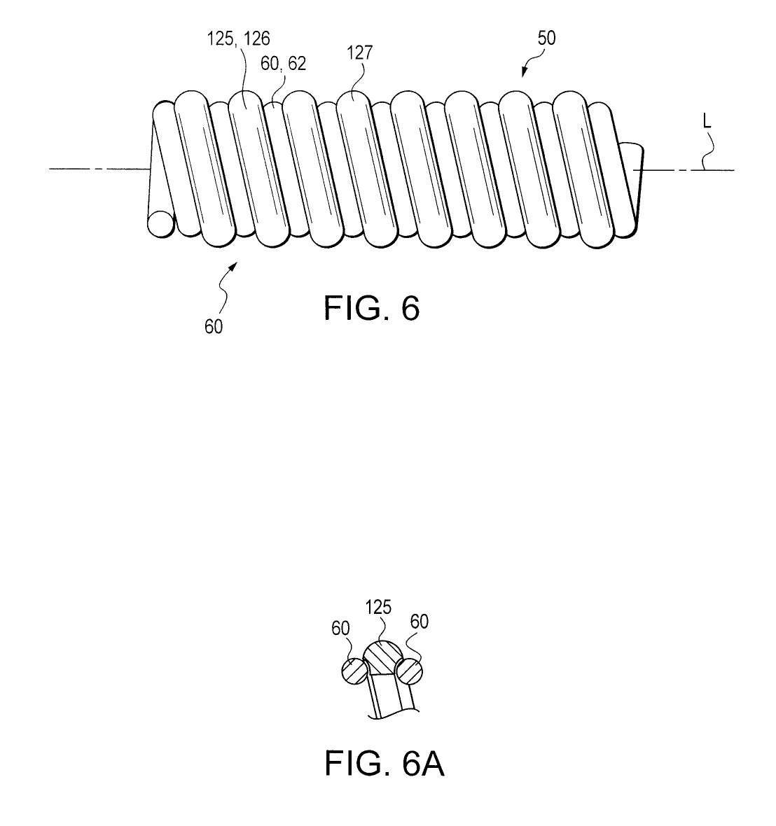

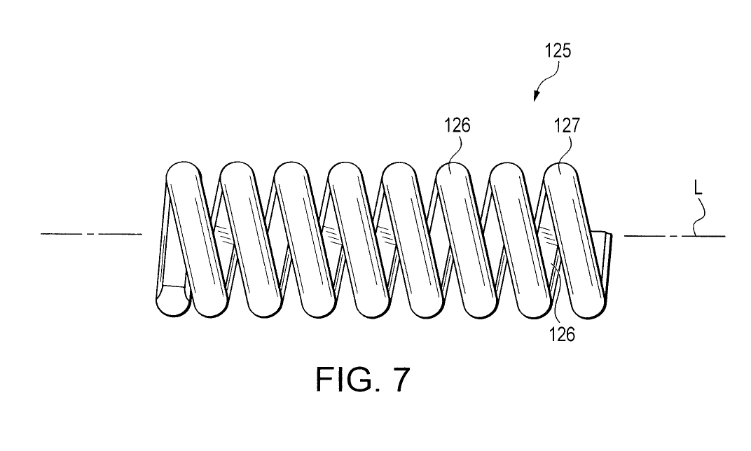

The wear disk 56 is shown in FIG. 4 in front elevational view and in FIG. 5 in diametric cross-section. With reference now to those figures, and with continued reference to FIGS. 2, 3A, and 3B, the wear disk 56 includes a central resilient body 80 and at least one wear detector prominence 82. In its preferred form, the resilient body 80 is substantially circular and may be annular if the circular opening 78 is increased in size. Also, the wear detector prominence 82 has a substantially annular shape and is carried on the resilient body 80.

The wear detector prominence 82 is preferably formed integrally with the body 80 such as in an extrusion or molding process. However, the prominence 82 may be bonded to the body using an adhesive or snap fit, ultrasonic welding techniques, or the like. In any case, the wear detector prominence 82 is configured to provide a visual indication of wear to an operator of the sewer cleaning machine 10. In that regard, the prominence 82 has at least one color change in a radial direction R. Thus, as outer regions of the disk 56 are worn away by abrasion or the like during use, the operator can visually detect the color change and determine a wear condition of the cable 60 by inference based upon the observed current color of the wear detector prominence 82.

As a first example, the outer periphery 84 of the wear detector may be black, the inner portion 86 thereof may be white, and the portion therebetween may be provided to have a white to black color gradient in a radially outward direction R. As another example, the outer periphery 84 of the wear detector may be white, the inner portion 86 thereof may be black, and the portion therebetween may be provided to have a black to white color gradient in the radially outward direction R.

Although white and black colors are suggested by way of example, any colors may be used to provide a suitable color gradient in the radial direction. The gradient may be a smooth transition such as shades of gray, or may be provided as abrupt color changes in the radially direction R.

Preferably, and with particular reference to FIG. 5, the wear detector prominence 82 includes a color gradient 90 in the form of a set of bands 92, 94, 96 of colored material forming the wear disk 56. The outer most band 92 is a green material, preferably a green nylon or the like and is bonded with the next inner band 94 formed of a yellow material. The middle band 94 is in turn carried on the next inner band 96 which is preferably formed of a red material. In the preferred embodiment illustrated in FIG. 5, the users of the cleaning machine 10 with the snake 26 carrying a wear indicator 50 in the form of the wear disk 56 thus described can visually determine a wear condition as the wear detector prominence 82 transitions from green to yellow, then to red, through abrasion or the like.

In certain embodiments, it is important for the wear detector prominence 82 to experience a size reduction at the same rate as the cable 60 because wear on the wear disk 56 is used to infer wear on the cable 60. Essentially, the wear disk acts as a proxy for visual signs of wear on the cable 60 which, because of its material properties, would be very difficult to resolve visually. However, it is to be understood that the present invention is not limited to wear indicators or wear elements undergoing wearing at the same rate at which the snake or cable wears. Although in certain applications this may be preferred, other applications may dictate other relative wear strategies. Generally, the size and/or geometry of a preferred embodiment wear indicator or wear element is dependent upon an overall wear rate of the wear indicator and the cable. However, due to the materials typically used for the wear indicators, the rate of wear for the indicators will typically be faster than that of the cable.

A preferred holding structure 100 for ensuring correspondence between the wear on the wear disk 56 and the wear on the cable 60 is illustrated in FIG. 5. As shown there, the structure 100 includes a set of first and second opposed concave surfaces 102, 104 defined by the wear detector prominence 82 portion of the wear disk 56. The concave surfaces 102, 104 are preferably shaped having a contour to intermatingly engage with the outer surface or shoulders of the steel wire 64 of the cable 60 on opposite sides of the helical gap 66. As such, they function to capture the wear disk 56 between the leading and trailing turn pairs 68, 70 (FIG. 2) when the disk 56 is positioned in the helical gap 66 defined by the cable 60. The disk 56 is essentially captured between successive convolutions of the wire 64 and is thereby prevented from radial movement relative to the snake. Preferably the concave surface 102 is in the form of a circular groove defining a concave depression extending in a circular fashion about the periphery on one face of the wear disk 56, with the concave surface 104 extending in identical fashion along an opposite face of the wear disk 56.

In another form as shown in FIG. 5A, the wear detector prominence 82′ of a wear disk 56′ has an outer button-like cap portion 110 provided in an area of the color gradient 90′. The cap portion 110 is rounded as shown and thereby helps prevent the prominence 82′ from inadvertently snagging on sharp edges of pipe workpieces or on items within the pipes. In that regard, a smooth outwardly directed convex arcuate surface 112 spans adjacent turns of the coil (not shown). The arcuate surface 112 extends radially outwardly beyond the outer radial terminus of the turns of the coil so that the cap portion 110 is positioned so that it is subjected to wear during use of the cable. The holding structure 100 described above including the oppositely directed concave surfaces 102, 104 help hold the wear element 52′ in place relative to the cable 60. Preferably, the wear detector prominence 82′ includes a color gradient 90′ in the form of a set of bands 92′, 94′, 96′ of colored material forming the wear disk 56′. The outer most band 92′ is a green material, preferably a green nylon or the like and is bonded with the next inner band 94′ formed of a yellow material. The middle band 94′ is in turn carried on the next inner band 96′ which is preferably formed of a red material. Similar to the embodiments described above, the users can visually determine a wear condition as the wear detector prominence 82′ transitions from green to yellow, then to red, through abrasion or the like.

In yet another form, as shown in FIG. 5B, the wear detector prominence 82″ of a wear disk 56″ has an outer button-type enlarged cap portion 114 provided in an area of the color gradient 90″. Preferably, the cap portion 114 spans multiple adjacent turns of the coil and, to that end, includes upwardly directed scalloped surfaces 116 contoured to matingly engage the outer shoulder surfaces of the cable 60 when the wear element 52″ is installed onto the cable. In particular, in the embodiment illustrated, the cap portion 114 would span about four to five (4-5) turns. However, cap portions 114 having other sizes are contemplated as well. A smooth outwardly directed convex arcuate surface 118 spans adjacent turns of the coil and helps prevent the prominence 82″ from inadvertently snagging on sharp edges of pipe workpieces or on items within the pipes. Preferably, the wear detector prominence 82″ includes a color gradient 90″ in the form of a set of bands 92″, 94″, 96″ of colored material forming the wear disk 56″. The bands are green, yellow, and red, respectively. The users can visually determine a wear condition as the wear detector prominence 82″ transitions from green to yellow, then to red, through abrasion or the like. In addition, the cap portion is large and, therefore, is readily visible to the operator. The holding structure 100 using concave surfaces 102 and 104 may also be optionally used.

In yet another form, as shown in FIG. 5C, the wear detector prominence 82′″ of a wear disk 56′″ has an outer pyramidal-shaped cap portion 119 provided in an area of the color gradient 90′″. The cap portion 119 is rounded as shown and thereby helps prevent the prominence 82′″ from inadvertently snagging on sharp edges of pipe workpieces or on items within the pipes. In that regard, a smooth outwardly directed convex arcuate surface 120 is provided on the radially outward end of the prominence 82′″. The arcuate surface 120 extends radially outwardly beyond the outer radial terminus of the turns of the coil and the cap portion 119 is positioned so as to be subjected to wear during use of the cable. The holding structure 100 described above including the opposite concave surfaces 102, 104 help hold the wear element 52′″ in place relative to the cable 60. Preferably, the wear detector prominence 82′″ includes a color gradient 90′″ in the form of a set of bands 92′″, 94′″, 96′″ of colored material forming the wear disk 56′″. The bands are green, yellow, and red, respectively. As can be seen, the outer band 92′″ has a smaller longitudinal cross section than the second band 94′″. The users can visually determine a wear condition as the wear detector prominence 82′″ transitions from green to yellow, then to red, through abrasion or the like. Although the wear detector prominence 82′″ forms a simple cone shape it is also possible to provide it in a wide variety of other shapes and sizes such as in other tapered shapes or square or rectangular shapes.

In still yet another form, as shown in FIG. 5D, the wear detector prominence 82″″ has an outer button-type enlarged cap portion 87 provided in an area of the color gradient 90″″. Preferably, the cap portion 87 spans multiple adjacent turns of the coil and, to that end, includes upwardly directed scalloped surfaces 91 contoured to matingly engage the outer shoulder surfaces of the cable 60 when the wear element 52″″ is installed onto the cable. In particular, in a preferred embodiment, the cap portion 87 would span about four to five (4-5) turns. However, cap portions 87 having other sizes are contemplated as well. As with the embodiments of FIGS. 5, 5A, 5B, and 5C, the wear detector prominence 82″″ of the wear element 56″″ includes a color gradient 90″″ in the form of a set of bands 92″″, 94″″, and 96″″ as previously described. The cap portion 87 is preferably relatively large and, therefore, is readily visible to the operator.

It will be appreciated that in each of the preferred embodiments depicted in FIGS. 5A, 5B, and 5D, other visual indications besides color can be utilized to signal wear of the wear indicators. For example, the shape or one or more dimensions such as width of the indicator may provide an indication of wear.

FIGS. 6 and 7 show a further preferred embodiment of the subject wear feature 50. FIG. 6 illustrates a wear form 125 installed with the cable 60. FIG. 7 illustrates the wear form 125 by itself. As shown there, a wear form 125 includes a helical body portion 126 carried within the outer body member 62 of the cable 60. The helical body portion 126 has along its periphery at least one wear detector prominence 127 extending radially outwardly between adjacent convolutions of the wire 60. The wear form 125 is essentially equivalent to a concatenated succession of the wear disk 56 shown in FIGS. 2-5 and formed as a unitary structure. Preferably, the wear form 125 is installed onto the cable 60 from end to end thereof and during manufacture.

One advantage of the continuous wear form 125 is that wear on it permits monitoring of wear over the entire length of cable directly. It may be possible to cause excessive wear in localized regions of the cable through use thereof in certain applications. In that event, the segment of the body portion 126 in the localized region would provide a visual indication to the operator of the condition. In this example, the wear form would become red in the localized region and may be either yellow or green in the remainder of the cable. Alternatively, a plurality of wear disks 56 could be provided along the length of the cable 60 at spaced apart locations such as, for example, every one (1) foot along the length of the cable.

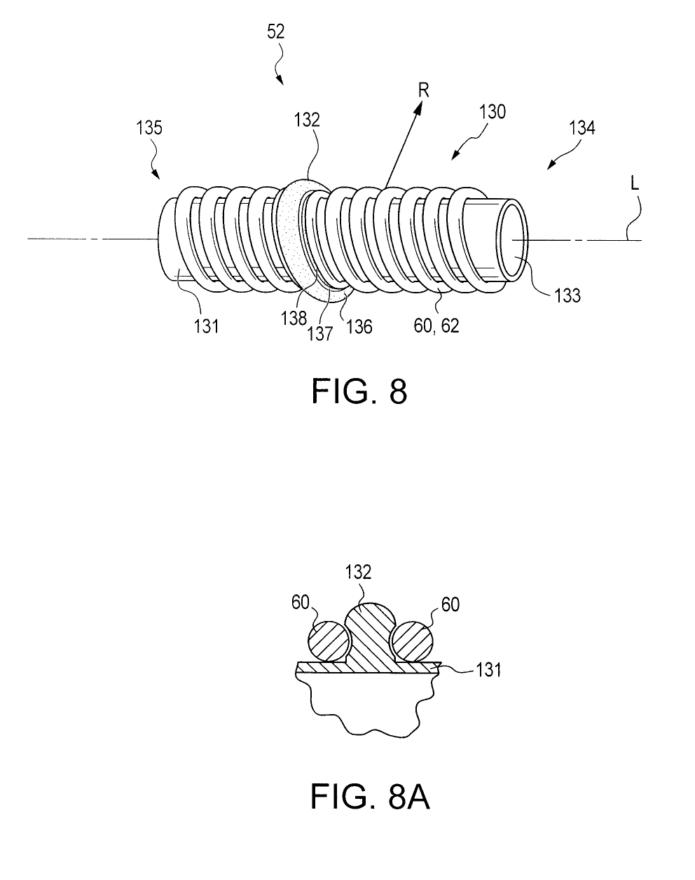

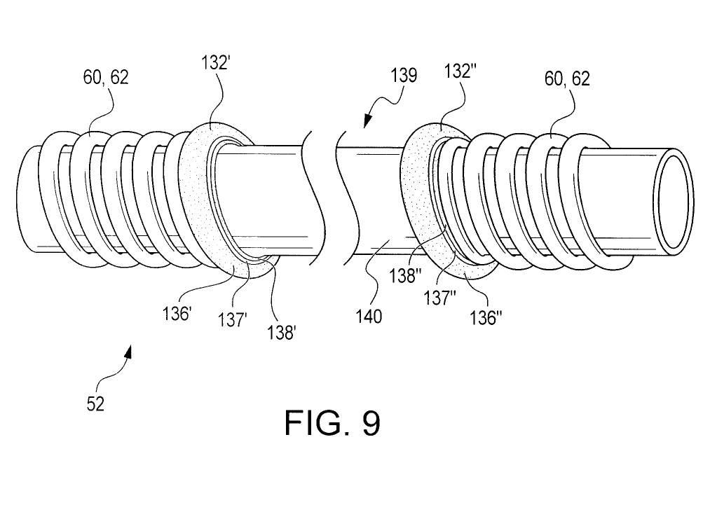

FIG. 8 shows a wear feature 52 formed in accordance with yet a further embodiment. As shown there, the wear feature 52 is in the form of an elongate cylinder 130 including a resilient tubular body member 131 configured to be carried within the hollow region or space created by the body member 62 of the cable 60. At least one wear detector prominence 132 is carried on the cylinder 130 and extends radially outwardly therefrom. The wear detector prominence 132 has a generally helical shape as shown and, when the cylinder 130 is installed in conjunction with a cable 60, the wear detector prominence 132 extends radially outwardly in a direction R between at least one selected turn of the helically coiled outer body of the cable 60. In its preferred form, the cylinder 130 defines an opening 133 extending from a first end 134 to a second end 135 thereof. Preferably, the opening is continuous through the cylinder to readily accommodate an inner cable (not shown) for use of the cylinder 130 in connection with “inner core” cables including vinyl-wrapped inner cores and the like. However, the body member 131 may be solid and formed of a flexible or compressible material such as a vinyl or a foam to permit the snake to adequately flex during use.

It is to be appreciated that, in order to best provide a visual indication of an amount of wear on the cable, the wear detector prominence 132 is formed of a material having at least one color change in a radial direction R. In that regard, the wear detector prominence 132 may provide a black to white transition in a radially outward direction, a white to black transition, or one or more transitions between a set of selected colors. Preferably, an outer color band 136 is green in color to indicate a new cable or a cable having only small amounts of wear. A second color band 137 is provided radially inwardly of the outer color band 136 and is preferably yellow in color. The yellow second color band 137 indicates that the cable is worn though yet usable. Lastly, a red inner band 138 is arranged as shown to provide a visual indication that the cable is worn beyond its useful life.

Referring to FIGS. 2B, 5E, 6A and 8A, partial cross sections of various preferred embodiment indicators are shown to further illustrate the range of configurations between adjacent coils of wire and a wear indicator disposed therebetween. For example, FIG. 2B is a partial cross section of the snake 60 and wear indicator 56 shown in FIG. 2. In this configuration, the lateral sides of the wear indicator 56 merely contact adjacent coils 60. FIG. 5E is a partial cross section of the wear indicator 56 shown in FIG. 5 disposed between adjacent coils 60. In this embodiment, the recessed lateral receiving regions or concave surfaces 102, 104 function to increase the amount of surface contact to thereby better engage an adjacent coil 60. FIG. 6A is a partial cross section of the snake and wear indicator 125 shown in FIG. 6. There, another configuration for the wear indicator 125 is depicted, with lateral recessed receiving regions for better engaging adjacent coils 60. FIG. 8A is a cross sectional view of the snake and wear indicator 132 depicted in FIG. 8. The wear indicator 132 may also be provided with lateral recessed receiving regions for engaging adjacent coils.

FIG. 9 shows yet another embodiment of a wear feature 52 in the form of an elongate cylinder 139 including a resilient cylindrical body member 140. Similar to the embodiment shown in FIG. 8, the body member 140 is configured to be carried within the hollow region or space created by the body member 62 of the cable 60. A plurality of wear detector prominences 132′, 132″ are carried on the cylinder 139 and each extend radially outwardly therefrom. Each of the wear detector prominences 132′, 132″ may provide a black to white transition in a radially outward direction, a white to black transition, or one or more transitions between a set of selected colors. Preferably and as shown, an outer color band 136′, 136″ is green in color to indicate a new cable or a cable having only a small amount of wear. A second color band 137′, 137″ is provided radially inward of the outer color band 136′, 136″ and is preferably yellow in color. The yellow second color band 137′, 137″ indicates that the cable is worn though yet usable. Lastly, a red inner band 138′, 138″ is arranged as shown to provide a visual indication that the cable is worn beyond its useful life. It is to be appreciated that a further embodiment (not shown) includes a single wear detector prominence 132′″ extending from end to end of the elongate cylinder 139 in a continuous fashion. This embodiment essentially concatenates a series of the wear detector prominences 132′, 132″ along the longitudinal axis L. In that way, wear on the entire length of the cable can be observed.

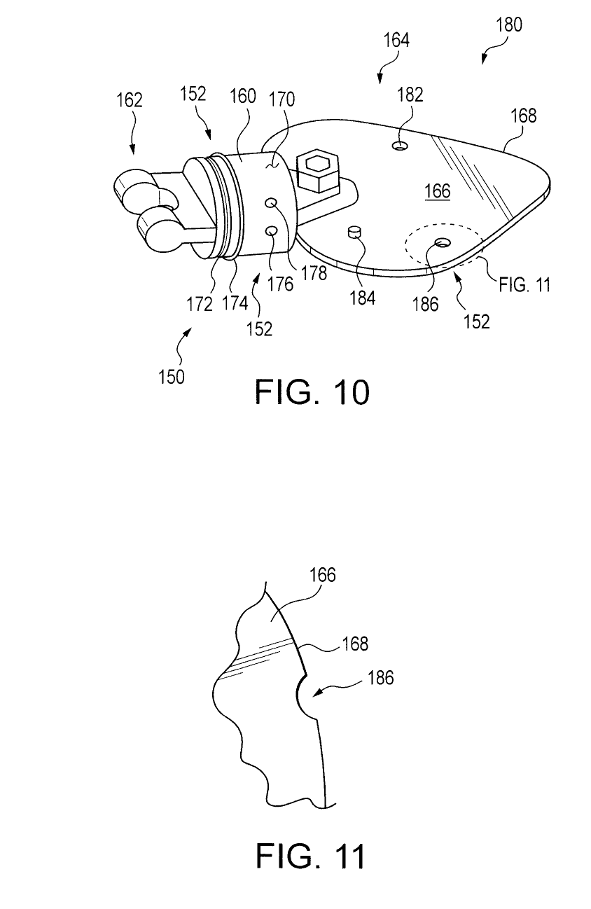

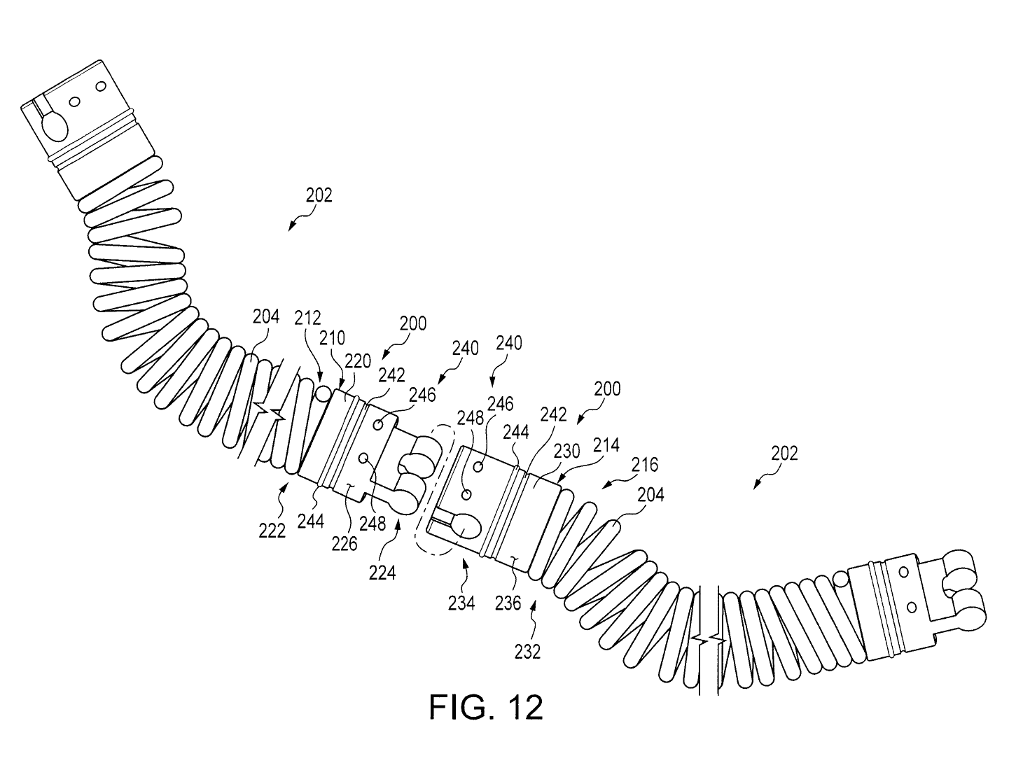

Turning next to FIG. 10, a tool 150 for use on the distal end of a flexible plumbers snake 26 of the type described above includes a plurality of wear indicators 152 arranged at various locations thereon. The exemplary tool 150 includes a body 160 including a connection portion 162 for selectively connecting the body 160 of the tool 150 with a corresponding connection portion (FIG. 12) at the distal end of an associated plumber snake (not shown) according to well known techniques. A working member 164 is carried on the body 160 as shown. In the exemplary embodiment shown, the working member is provided in the form of a flat grease blade 166 having a spade-shaped cutting edge 168. As understood by those skilled in the art, the working member 164 is configured for cleaning debris with an associated drain during use of the tool. A plurality of wear indicators 152 are provided on at least one of the body 160 and the working member 164 for providing a visual indication of wear in the tool 150.

In the embodiment shown in FIG. 10, the body 160 defines a substantially cylindrical shaped outer surface 170. A first wear indicator is provided in the form of a circular recessed groove 172 defined in the surface 170 of the body 160. A second wear indicator is provided in the form of a raised circular rib 174 extending radially outwardly from the surface 170 of the body 160. Other wear indicators are provided on the body 160 as well. In that regard, a dimple or recess 176 is provided as shown, and, further, a raised tab 178 is included. It is to be appreciated that one or more of the wear indicators 150 provided on the body 160 may be used as desired together, alone, or in various combinations thereof. Further, any of the wear indicators may be provided or arranged to form symbols intelligible to human operators of the tool, such, as, for example, to spell out “WEAR INDICATOR” or “RIDGE TOOL” wherein the operator's attention is drawn to the indicia/wear indicator during normal use of the tool.

During use of the subject tool 150, an operator can readily observe changes in each of the wear indicators provided on the body 160. More particularly, with regard to the circular channel or groove 172 and the dimple 176, the operator can readily observe these features “disappearing” as the outer surface 170 of the body 150 wears away through abrasion, or the like. Similarly, an operator can observe the circular ring 174 and the tab 178 smoothing or flattening during use of the tool through abrasion, or the like.

In addition to the above, other wear indicators 152 are provided on the tool 150 as well. In that regard, a wear indicator in the form of a formation 180 defined on the blade 166 is provided as well. In a first form, the formation 180 is in the form of one or more holes 182 and 186 extending through the blade. In another form, the formation is a tab or protuberance 184 formed on the blade. The protuberance eventually wears away and is observable by the operator during use of the tool. It is to be noted that as the edge 168 wears during use of the tool, the distance between the hole 186 and the edge 168 reduces to a state where the hole 186 joins with and partially defines the edge 168. This is shown in an exaggerated fashion in FIG. 11.

FIG. 12 shows a wear indicator 200 in each of two engagable portions 202 of a sectional plumbers cable. With reference now to that Figure, each of the plumbers cable portions 202 includes an elongate outer body member 204 defining a longitudinal axis L (not shown), a first coupling 210 on a first end 212 of the elongate outer body member, a second coupling 214 on a second end 216 of the elongate outer body member opposite from said first end, and a wear indicator 200 on at least one of the first 210 and second 214 coupling portions. As understood by those skilled in the art, the outer body 204 is formed of a length of steel wire helically coiled in turns along the longitudinal axis L. In the form illustrated, the first and second couplings 210, 214 are selectively intermatable with each other to connect together multiples of such portions 202 with the elongate outer body member having said first and second couplings on said opposite ends thereof. The wear indicator 200 provides a visual indication of wear on the flexible plumbers cable section 202. It will be appreciated that the present invention wear indicators, wear elements, and assemblies utilizing such are not limited to the version shown in FIG. 12. Instead, the present invention can be used in a wide array of configurations including but not limited to sectional configurations and interchangeable end configurations which can engage a specific tool or powered device.

Specifically, in the embodiment of FIG. 12, the first coupling 210 includes a first body 220, a first cable connection portion 222 on one side of the first body for coupling the first coupling with the first end 212 of the elongate outer body member, and a male quick connect 224 on the other side of the first body and configured for selective attachment with said second coupling 214. The first body defines a substantially cylindrical shaped first outer surface 226 which is provided with the wear indicators 240 of the present embodiment. Similarly, the second coupling 214 includes a second body 230, a second cable connection 232 on one side of the second body for coupling the second coupling with the second end 216 of the elongate outer body member, and a female quick connect 234 on the other side of the second body and configured for selective attachment with said male coupling 224. The second body also defines a substantially cylindrical shaped second outer surface 236 which is provided with the wear indicators 240 of the present embodiment.

A first wear indicator 240 is provided in the form of a circular groove 242 defined in the outer surfaces 226, 236 of the bodies 220, 230. A second wear indicator is provided in the form of a circular rib 244 extending radially outwardly from the surfaces of the bodies. Other wear indicators are provided on the bodies as well. In that regard, a dimple or recess 246 is provided as shown, and, further, a raised tab 248 is included. It is to be appreciated that one or more of the wear indicators provided on the bodies may be used as desired together, alone, or in various combinations thereof. Further, any of the wear indicators may be provided or arranged to form symbols intelligible to human operators of the tool, such, as, for example, to spell out “WEAR INDICATOR” or “RIDGE TOOL” wherein the operator's attention is drawn to the indicia/wear indicator during normal use of the tool 202.

During use of the subject tool, an operator can readily observe changes in each of the wear indicators provided on the bodies 220, 230. More particularly, with regard to the circular channels or grooves 242 and the dimple 246, the operator can readily observe these features “disappearing” as the outer surfaces of the bodies wear away through abrasion or the like during use. Similarly, an operator can observe the circular ring 244 and the tab 248 smoothing or flattening during use of the tool through abrasion, or the like. The dimples may be filled with a highly visible material such as a colored plastic material or paint so that the operator can readily observe changes in the size of the dimple caused by wear. Also, the ring and/or tab may be formed as a projection or may be bonded to the tool body such as by using a suitable adhesive for example.

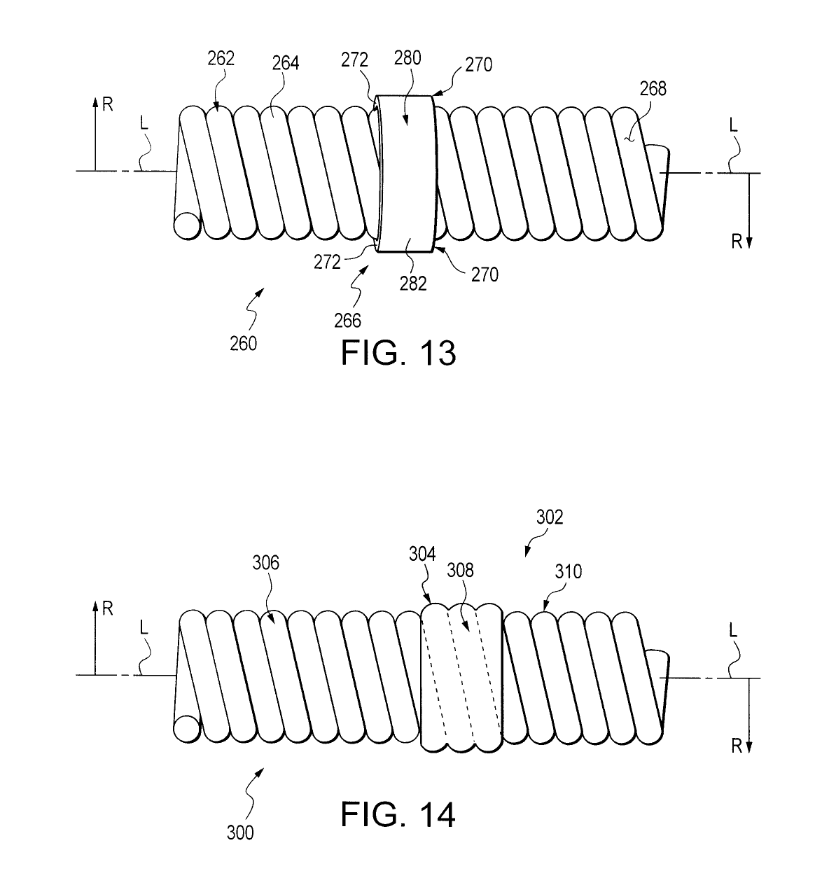

FIG. 13 is a longitudinal view of a central portion of a plumbers snake showing a wear element wear detector 260 in accordance with a still further embodiment. In accordance with this embodiment, a flexible plumbers cable 262 is provided including an elongate outer body member 264 defining a longitudinal axis L, and a wear indicator member 266 carried by the outer body member 264. The elongate outer body member 264 is formed of a length of steel wire 268 helically coiled in turns along the longitudinal axis L. The wear indicator member 266 carried by the outer body member 264 has along its outer periphery 270 at least one wear detector prominence 272 extending radially outwardly from the helically coiled outer body member 264. In one form, the at least one wear detector prominence 272 has at least one color change in the radial direction R providing a visual indication of wear on the cable. It will be appreciated that numerous strategies and structures can be used to indicate wear. For example, the band 260 could be formed from a plurality of layers of differently colored materials such as combinations of metals having different appearances from one another. These differences may be color-based or be based upon other physical properties. The plurality of layers could also use combinations of materials in addition to or instead of metal, such as various polymeric materials.

Another aspect included by the present invention is the provision of a band 260. Excessive wear of the band 260 could be considered to be wearing that causes the band 260 to become detached from the snake or cable. This strategy may provide an economical and simple means for providing a wear indicator on a drain cleaning snake.

In the embodiment illustrated in FIG. 13, the wear indicator member 266 carried by the outer body member 264 is a hollow cylindrical member 280 clamped, secured, or otherwise attached to the outer surface of the outer body member 264. The hollow cylindrical member 280 may be one of a steel clamp 282 and a plastic clamp (not shown). Further, the hollow cylindrical member 280 is selectively one of a metal PEX clamp and a plastic pull tie clamp although any form of circular protrusion can be used by coupling or otherwise clamping or affixing the wear detector to the cable body. Typically, however, the steel PEX clamp is crimped onto the cable using an otherwise standard pressing or crimping tool. Further, the cylindrical member may be a standard ASTM copper crimp ring which is pressed or crimped onto the outside of the cable body using standard tools. The plastic pull tie may be a “zip” tie for example.

It will be understood that in no way is the present invention limited to the particular embodiment depicted in FIG. 13. That is, the present invention wear indicators can be formed from nearly any suitable material besides the noted metals and plastics. Other metals and polymeric materials could be used for forming the wear indicators. Moreover, it is contemplated that aggregates or compound mixtures or combinations of two or more materials could be used.

FIG. 14 is a longitudinal view of a central portion of a plumbers snake 300 showing a wear feature wear detector 302 in accordance with yet a still further embodiment. In this embodiment, the wear indicator member 304 carried by an outer body member 306 is a coating 308 adhered to the outer periphery 310 of the outer body member 306. The coating is a one of an epoxy and paint although other materials may be used. Typically, the cable body is first cleaned to remove contaminants such as oil and then coated to ensure good adhesion. However, the wear indicator may be applied to the cable by a plating process. Further, the epoxy may be a rubberized epoxy. The epoxy may be applied onto the cable body in layers of different colors in sequential manufacturing steps. In that way, an operator of the tool may more easily determine wear in the tool by observing color changes in the coating 308 as the outer surface thereof wears during use of the tool. As previously noted, in no way are the present invention wear indicators limited to the specific versions described and shown herein. Instead, a wide array of materials, shapes, configurations, and approaches may be adopted in accordance with the present invention. In certain embodiments, it will be appreciated that the coating or material forming the coating can be applied to the snake or cable when the snake is in a state of tension so that adjacent coils are displaced apart from one another. This allows the coating to adhere to regions of the snake that might otherwise not be exposed if the snake were not tensioned. Applying coating to these regions in many applications, promotes adherence and retention of the coating to the underlying snake or coiled wire.

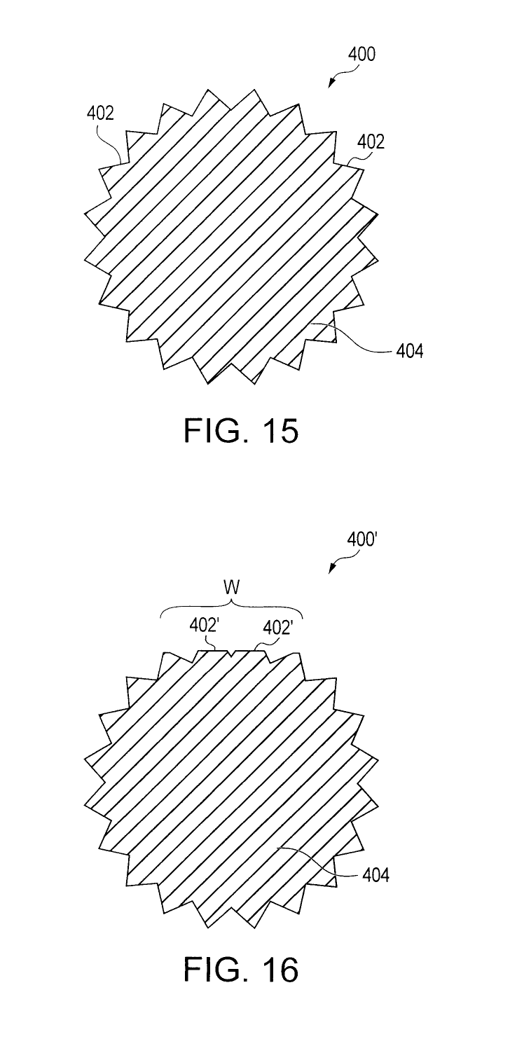

In yet another aspect, the present invention provides a strategy by which a particular cross sectional configuration is used for the wire in a plumbers snake, which provides an indication of wear. For example, FIG. 15 illustrates a representative cross section of a wire 400 having a main body 404 and a plurality of outwardly extending ridges or other projections 402. It will be understood that the wire having such a cross section shape would be formed into a helically wound plumbers snake. FIG. 16 illustrates the wire 400′ after significant wear, depicted in region W. In that region, one or more of the outwardly extending projections 402′ are worn or otherwise reduced in height or changed in shape.

It will be appreciated that any of the various features described herein which are associated with one embodiment, can be used or otherwise combined with one or more other features of other embodiments.

The invention has been described with reference to the preferred embodiments. Obviously, modifications and alterations will occur to others upon reading and understanding the preceding detailed description. It is intended that the invention be construed as including al such modification and alteration insofar as they come within the scope of the appended claims or the equivalents thereof.

Having thus described the preferred embodiments, it is now claimed:

1. A flexible plumbers cable comprising:
an elongate outer body member defining a longitudinal axis, the outer body member being formed of a length of steel wire helically coiled in turns along the longitudinal axis; and,
a resilient intermediate body member carried by the outer body member and having along its periphery at least one wear detector prominence extending radially outwardly between at least one selected turn of the helically coiled outer body member, the at least one wear detector prominence having at least one color change in said radial direction providing a visual indication of wear on the cable.

2. The flexible plumbers cable according to claim 1 wherein:
the resilient intermediate body member is disk-shaped and includes a circular central body portion; and,
the at least one wear detector prominence is annular and carried on the intermediate body member.

3. The flexible plumbers cable according to claim 2 wherein the at least one wear detector prominence is formed integrally with the central body portion.

4. The flexible plumbers cable according to claim 2 wherein the intermediate body member forms a slit extending radially through the central body portion and the at least one wear detector prominence to enable portions of the intermediate body member adjacent said slit to be spaced apart along said longitudinal axis for contouring the body into a helical coil in accordance with said steel wire along said horizontal axis.

5. The flexible plumbers cable according to claim 1 wherein:
the resilient intermediate body member is spiral-shaped and includes a circular central body portion; and,
the at least one wear detector prominence is carried on the intermediate body member.

6. The flexible plumbers cable according to claim 5 wherein the at least one wear detector prominence is formed integrally with the central body portion.

7. The flexible plumbers cable according to claim 6 wherein the at least one wear detector prominence extends radially outwardly between said at least one selected turn of the helically coiled outer body.

8. The flexible plumbers cable according to claim 1 wherein:
the elongate outer body member is hollow by said length of said steel wire helically coiled in said turns defining a hollow open region therein;
the resilient intermediate body member extends longitudinally within the hollow outer body member; and,
the at least one wear detector prominence extends radially outwardly between said at least one selected turn of the helically coiled outer body.

9. The flexible plumbers cable according to claim 8 wherein the at least one wear detector prominence is spiral shaped.

10. The flexible plumbers cable according to claim 9 wherein:
the elongate hollow outer body member has opposite proximal and distal ends; and,
the resilient intermediate body member extends longitudinally within the outer body member substantially entirely between said proximal and distal ends.

11. The flexible plumbers cable according to claim 10 wherein the at least one wear detector prominence includes a plurality of wear detector prominences carried by intermediate body member at locations spaced apart along said longitudinal axis.

12. The flexible plumbers cable according to claim 10 wherein the at least one wear detector prominence is spiral shaped and extends radially outwardly between a plurality of turns of the elongate hollow outer body member substantially entirely between said proximal and distal ends of the elongate hollow outer body.

13. The flexible plumbers cable according to claim 1 further including:
a plurality of resilient intermediate body members carried within the outer body member at locations spaced apart along said longitudinal axis, each of the plurality of resilient intermediate body members having along its periphery at least one wear detector prominence extending radially outwardly and including at least one color change in said radial direction.

14. The flexible plumbers cable according to claim 1 wherein:
the at least one color change of the wear detector prominence is a color gradient in said radial direction.

15. The flexible plumbers cable according to claim 14 wherein said color gradient includes a one of a light to dark gradient in said radial direction and a dark to light gradient in said radial direction.

16. The flexible plumbers cable according to claim 14 wherein said color gradient includes:
a green to yellow change in said radial direction; and,
a yellow to red change in said radial direction.

17. The flexible plumbers cable according to claim 1 wherein:
the elongate outer body member is formed of a length of spring steel; and,
the at least one wear detector prominence is formed of a one of a plastic and a nylon material.

18. The flexible plumbers cable according to claim 1:
wherein the elongate outer body member is hollow by said length of said steel wire helically coiled in said turns defining a hollow open region therein; and,
further including an inner concentrically aligned flexible metal core disposed within the elongate hollow outer body member and extending longitudinally thereof, the resilient intermediate body member being disposed between the flexible metal core and the hollow outer body member.

19. The flexible plumbers cable according to claim 1 wherein the elongate hollow outer body member is formed of a length of steel wire formed of a double wound coil with adjacent pairs of convolutions of the coil being in substantial abutment with one another and said at least one wear indicator prominence extending radially outwardly between said adjacent pairs of convolutions of the coil.

20. A tool for use on the distal end of a flexible plumbers cable, the tool comprising:
a body including a connection portion for selectively connecting the body of the tool with the distal end of the plumbers cable;
a working member carried on the body, the working member being configured for cleaning debris within an associated drain during use of the tool; and,
a wear indicator on at least one of the body and the working member, the wear indicator providing a visual indication of wear on the tool.

21. The tool according to claim 20 wherein:
the body defines a substantially cylindrical shaped outer surface; and
the wear indicator is a formation defined on said outer surface.

22. The tool according to claim 21 wherein the formation is at least one of:
a raised protuberance formed on the outer surface; and,
a recess formed on said outer surface.

23. The tool according to claim 20 wherein:
the working member includes a blade having an edge for cutting the debris within the associated drain during use of the tool; and,
the wear indicator includes a formation defined on the blade.

24. The tool according to claim 23 wherein the formation is at least one of:
a raised protuberance formed on the blade; and,
a hole adjacent said edge and extending through the blade.

25. A flexible plumbers cable section comprising:
an elongate outer body member defining a longitudinal axis, the outer body being formed of a length of steel wire helically coiled in turns along the longitudinal axis;
a first coupling portion on a first end of the elongate outer body member;
a second coupling portion on a second end of the elongate outer body member opposite form said first end, the first and second coupling portions being selectively intermatable with each other to connect together multiples of said elongate outer body member having said first and second couplings portions on said opposite ends thereof; and,
a wear indicator on at least one of the first and second coupling portions, the wear indicator providing a visual indication of wear on the flexible plumbers cable section.

26. The flexible plumbers cable section according to claim 25 wherein:
said first coupling portion includes:
a first body defining a substantially cylindrical shaped first outer surface;
a first cable connection portion on one side of the first body for coupling the first coupling portion with the first end of the elongate outer body member of said length of said steel wire; and,
a male quick connect portion on the other side of the first body and configured for selective attachment with said second coupling portion; and,
said second coupling portion includes:
a second body defining a substantially cylindrical shaped second outer surface;
a second first cable connection portion on one side of the second body for coupling the second coupling portion with the second end of the elongate outer body member of said length of said steel wire; and,
a female quick connect portion on the other side of the second body and configured for selective intermatable attachment with said male quick connect portion.

27. The flexible plumbers cable section according to claim 25 wherein the wear indicator is a formation defined on at least one of the first outer surface and the second outer surface.

28. The flexible plumbers cable section according to claim 27 wherein the formation is at least one of a raised protuberance and a recess.

29. The flexible plumbers cable section according to claim 28 wherein the formation is a raised protuberance arranged to form symbols intelligible by a human operator of the flexible plumbers cable section.

30. The flexible plumbers cable section according to claim 28 wherein the formation is a recess pattern arranged to form symbols intelligible by a human operator of the flexible plumbers cable section.

31. A flexible plumbers cable comprising:
an elongate outer body member defining a longitudinal axis, the outer body member being formed of a length of steel wire helically coiled in turns along the longitudinal axis; and,
a wear indicator member carried by the outer body member and having along its outer periphery at least one wear detector prominence extending radially outwardly from the helically coiled outer body member.

32. The flexible plumbers cable according to claim 31 wherein the at least one wear detector prominence has at least one color change in said radial direction providing a visual indication of wear on the cable.

33. The flexible plumbers cable according to claim 31 wherein the wear indicator member carried by the outer body member is a hollow cylindrical member clamped to said outer periphery of the outer body member.

34. The flexible plumbers cable according to claim 33 wherein the hollow cylindrical member is a one of a steel clamp and a plastic clamp.

35. The flexible plumbers cable according to claim 34 wherein the hollow cylindrical member is a one of a steel PEX clamp and a plastic pull tie clamp.

36. The flexible plumbers cable according to claim 31 wherein the wear indicator member carried by the outer body member is a coating adhered to said outer periphery of the outer body member.

37. The flexible plumbers cable according to claim 36 wherein the coating is a one of an epoxy and paint.

38. The flexible plumbers cable according to claim 37 wherein the epoxy is a rubberized epoxy
